(19) United States
(12) Patent Application Publication
(10) Pub. No.: US 2005/0254881 A1
(43) Pub. Date: Nov. 17, 2005

(54) Flat Ink Cartridge for Writing Instruments

(76) Inventor: Xiaoge Gregory Zhang, Toronto (CA)

Correspondence Address: XIAOGE GREGORY ZHANG, 3 WEATHERELL ST., TORONTO, ON, M6S-1S6, CA

(21) Appl. No.: 10/906,923

(22) Filed: Mar. 12, 2005

Related U.S. Application Data
(60) Provisional application No. 60/570,323, filed on May 13, 2004.

(51) Int. Cl. A46B 5/02; B43K 23/02

(52) U.S. Cl. 401/131; 401/195

(57) ABSTRACT

A writing instrument having a thin and planar ink cartridge adapts for placement and storage in narrow or flat spaces. The thin and planar ink cartridge has a cavity-stabilizer inside the ink cartridge to provide mechanical stability of the cartridge and a stable volume of the cavity for ink storage within the cartridge. The writing instruments using thin and planar ink cartridges can be adapted for placement in wallets, checkbooks, notebooks, pockets, and in books and may function as bookmarks. The flat form of these writing instruments also provides a wide range of design possibilities to have variety of shapes resembling real or imagined objects and designs, and to display advertising, reference, educational, and entertainment information.

### FIELD OF THE INVENTION

This invention is related to ink cartridges, and more particularly to thin and planar ink cartridges for flat writing instruments that are adapted to fit in narrow spaces or flat surface such as in books like bookmarks, in wallets, in checkbook sleeves, and pocket notebooks.

### BACKGROUND OF THE INVENTION

Writing instruments have a known history of about two thousand years, evolving from quill pens, to fountain pens, and modernly to ballpoint pens. Historically, pens have been used for serious writing, casual note taking, to signing signatures. However, since the mid-1990s pens have been becoming merely tools for brief note taking and signing signatures. Personal computers, PDAs, and portable personal communicators are becoming the most important tools for writing, while carrying a pen has often become a burden. Since pens are no longer ubiquitous, a need has evolved to make pens convenient to store and instantly available should a need arise to take a brief note or sign a signature.

Many people reading books (readers) appreciate having a pen or highlighter handy for taking notes or making marks while they read. Readers may hold a pen in their hand, carry one in a pocket, or have one on a nearby table. However, since carrying a rigid cylindrical pen is a burden.

To increase the likelihood that a pen is available, readers have attached pens to books with a string, a clip, or a penholder. However, pens attached to books with strings or clips are neither esthetically desirable nor practical. Pens commonly supplied in stores, while comfortable to hold by hand, are typically round and bulky. If someone places a round and bulky pen inside a book, it can cause damage to the book, or it can easily fall out from the book.

Readers commonly use bookmarks to note the page they last read in a book. There are some non-cylindrical bookmark pens available in the market place. However, all of these pens use a cylindrical ink cartridge, and if they have a smaller than average diameter or are short, they contain a very limited volume of ink. If cylindrical ink cartridges are adapted to contain a lot of ink, they must be either thicker or longer, and they become unsuitable as bookmarks.

A patent search revealed a number of prior art inventions relating to flat pens and combination bookmark-pens. In particular, there has been a continuing effort to invent new bookmark products serving people reading books in need of a pen or highlighter. Grouping the prior art into two categories, we have those with an object to combine the function of a conventional pen and a bookmark and those with an object to provide flat writing instruments.

Conventional pen and bookmark combination prior art includes U.S. Pat. Nos.: D325,929, D452,270, 4,1628,00, 4,706,995, 5,016559, 5,072686, 5,095,846, 5,501,171, 5,829,903, 6,006,692, 6,446,803, 6,481,367, 5,984,558 and D429,499. These inventions provide a variety of bookmark and pen combinations. However, they are of only limited convenience to people reading books because the bookmarks have rather bulky penholders that remain outside of the book when the bookmark portions are placed in a book, they are inconvenient for use when stacking books, and they are a visual distraction.

Prior art planar pens all use conventional cylindrical ink cartridges or pen refills. Thin cylindrical cartridges have very limited ink storage volume. Thicker cylindrical cartridges in writing instruments, which can hold more ink, are bulky and not convenient to place in wallets, checkbook sleeves, and pocket notebooks.

Prior art flat or planar writing instruments include U.S. Pat. Nos. 4,243,338, 4,508,464, 4,568,213, 5,061,104, 5,678,939, and 5,897,261. U.S. Pat. No. 4,243,338 discloses a “Writing Instrument and Holder Assembly”, which is a flat pen with elongated cavity for holding a cylindrical ink cartridge. U.S. Pat. Nos. 4,508,464 and 4,568,213, entitled “Foldable Pen,” disclose a flat pen consisted of three panels, which are made of elastic materials that allow the panels to fold into a prismatic pen, providing a cavity in the middle panel for receiving a pen refill. U.S. Pat. No. 5,061,104, entitled “Foldable Flat Ball Point Pen,” discloses a flat pen consisting of two parts wherein the part with the pen pivots into the other part. Ross' U.S. Pat. No. 5,678,939, entitled “Card-Shaped, Hinged Writing Instrument,” discloses a flat pen consisting of two parts with the part having the pen adapted to pivot in the middle of the other. Goetz' U.S. Pat. No. 5,897,261, entitled “Ballpoint Pen for Credit Card Receiving Pocket,” describes a thin and flat pen with a cap adapted to conveniently be carried in a wallet and a pocket book, but it carries a minimal volume of ink because its writing cartridge is a conventional design tubular plastic ink reservoir.

No prior art writing instruments teaching the use of a thin and planar ink cartridge was found.

### SUMMARY OF THE INVENTION

A general object of the invention is to provide writing instruments that are convenient to store and carry, thereby increasing their availability when users have a need for a pen or highlighter. A particular object of the invention is to provide a thin and planar ink cartridge for use in hand writing instruments and markers, preferably containing more than a nominal amount of ink. An object of the invention is to provide flat writing instruments having thin and planar ink cartridges.

Preferably, the writing instruments comfortably fit between pages of a book, as do bookmarks. In a preferred embodiment, the writing instruments are adapted to comfortably fit in wallets, checkbook sleeves, and pocket notebooks, for convenient placement. An additional object of the invention provides writing instruments having a planar surface, for placement of indicia, for use in advertising, providing reference and educational information, and entertaining designs.

The word “planar” herein means flat or largely flat for describing a generally 2-dimensional flat form that may have some longitudinal and transversal curvatures.

### DRAWINGS—FIGURES

The accompanying drawings provide examples of objects, features and advantages of the present invention.

FIGS. 1A and 1B show a plan view and a longitudinal cross-sectional view of an embodiment of the invention flat pen that has a thin and planar ink cartridge with a writing tip, a casing, and a cartridge motion-enabling clip on the top panel of the casing.

FIGS. 2A, 2B, and 2C show a plan view, a longitudinal cross-sectional view, and a transversal cross sectional view of a thin and planar ink cartridge.

FIGS. 3A and 3B show plan and longitudinal cross sectional views of a flat pen with an anti-sliding mechanism between the ink cartridge, the casing, and a magnetic strip on the casing. FIG. 3C is a detailed cross sectional view of the anti-sliding device.

FIG. 4 shows plan view of a thin and planar pen with an alternative cartridge motion-enabling mechanism.

FIGS. 5A and 5B show plan and cross-sectional views of a flat pen with another alternative cartridge motion-enabling mechanism.

FIGS. 6A and 6B show plan and longitudinal views of a flat pen with another alternative cartridge motion-enabling mechanism.

FIGS. 7A, 7B, and 7C show the plan, longitudinal, and transversal views of a thin and planar pen with another alternative cartridge motion-enabling mechanism.

FIGS. 8A and 8B show plan and longitudinal views of a thin and planar pen with another alternative cartridge motion-enabling mechanism.

FIGS. 9A and 9B show perspective and transversal views of feather pen comprising a thin and planar ink cartridge adapted to receive a feather.

FIGS. 10A and 10B show plan and longitudinal views of a flat ink cartridge with a wide felt type tip.

FIG. 11 shows a plan view of a flat pen having a thin and planar ink cartridge.

FIG. 12 shows a plan view of a shorter alternative thin and planar pen.

FIG. 13 shows a perspective view of a thin and planar pen, wherein an ink absorbing material fills a cavity inside an ink cartridge.

FIG. 14 shows a perspective view of a casing with a thin and planar highlighter for mounting on the backside of a book.

### DRAWINGS—REFERENCE NUMERALS

2—casing; 4, 4A—ink cartridge; 6—writing tip; 8—cartridge motion-enabling clip; 10—opening on casing; 12—spacer; 14—cavity within casing; 16—front casing edge; 18—rear casing edge; 19—opening for writing tip; 20—side casing edge; 22—casing interior boarder; 24—ink cartridge cavity stabilizer; 26—cartridge side edge; 27—cartridge boarder strip; 28 cartridge front edge; 29—air venting hole; 30—cartridge rear edge; 32—cartridge cavity; 34—magnetic strip; 35—exposed part of ink cartridge; 36—anti-sliding device; 36a—corrugated strip on cartridge; 36b—corrugated strip on casing; 38—pen motion-enabling handles; 39—opening on the side of casing; 40—opening on casing; 42—spacer; 44—pen motion-enabling knob; 46—pen motion-enabling knob; 48, 50—off-centered oval wheel; 52—cartridge end strip; 54 opening on cartridge end strip; 56—washer; 58—rivet pin; 59—holes on casing; 60 spring; 62, 64, 68—pen motion enabling & locking knob; 70 opening on casing; 72—spring; 74—clip; 78—locking bar; 80—spring; 82—hole; 84—feather stem; 86—feather; 88—marking tip; 90—book; 92—book back cover; 94—casing; 96—thin and planar highlighter.

### DETAILED DESCRIPTION

### Preferred Embodiment

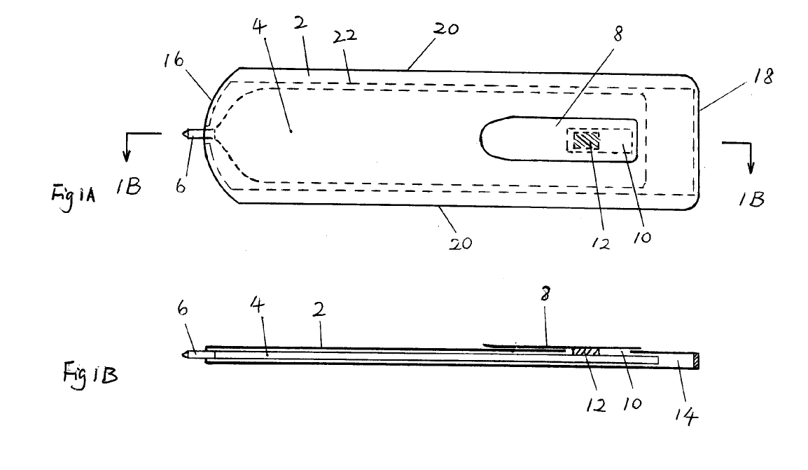

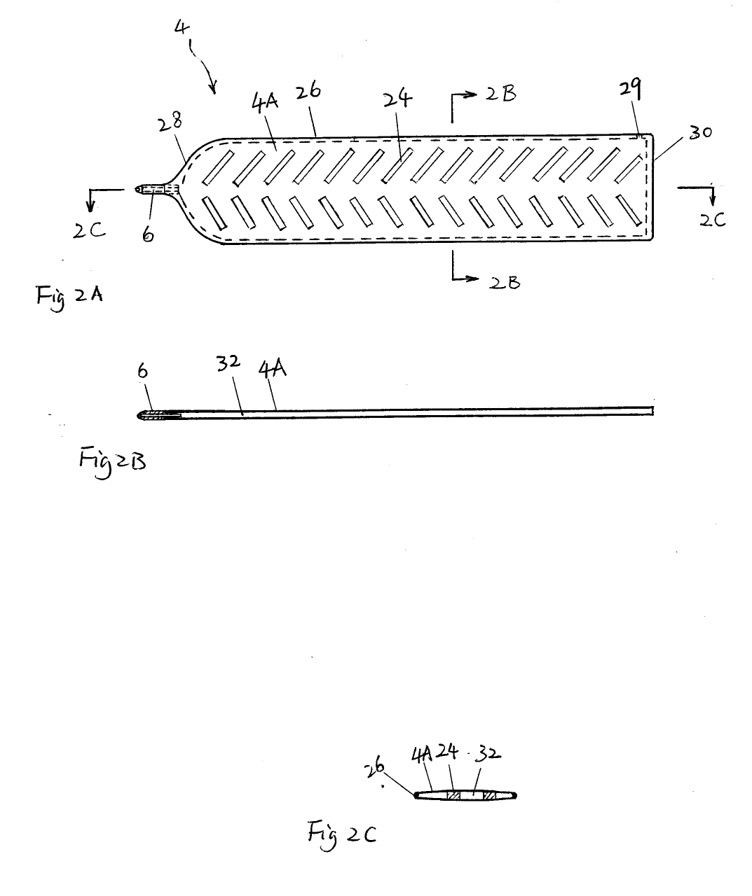

FIGS. 1A (plan view) and 1B (longitudinal cross sectional view) illustrate a preferred embodiment of the invention, wherein a writing instrument comprises a thin elongated planar ink cartridge 4 enclosed in a casing 2. A cartridge motion-enabling clip 8 is fixed on the ink cartridge by a spacer 12 through an opening 10 on casing 2. The cartridge motion-enabling clip can be mobilized by hand longitudinally to move the writing tip 6 in and out of the casing through the opening 19 at the front edge 16 of the casing.

The writing tip may be of any type but preferably comprises a conventional ballpoint or felt tip. The thickness, length, and shape of a writing tip may vary with the intended application for the writing instrument. Ballpoint or pointed felt-tip writing tips are generally preferred for pens. Wide-strip felt-tip writing tips are generally preferred for highlighters and markers. The thickness of the casing is adapted to be slightly larger than the cartridge thickness so that the cartridge can easily fit inside the casing. The casing opening 10 is elongated and wider than the spacer 12 and is sufficiently longer than the spacer 12 to allow moving the writing tip fully in and out of the casing. Preferably, an elastic material is covers the opening 19 at the front of the casing such that the opening opens when the writing tip is pushed outside the casing, but is closed when the writing tip is inside the casing to prevent drying of the ink. Preferably, the elastic material comprises a non-porous type of material, such as rubber. The casing material preferably comprises a sheet material, and more preferably comprises either metal or plastic sheeting.

The cartridge motion-enabling clip 8 comprises a thin strip. Preferably, the clip 8 is sized larger than the opening 10 such that the clip 8 fully covers the opening 10. The length of the clip 8 is adapted to allow clipping the pen on to pages in a document or a book. The spacer 12 is slightly thicker than the panel of the casing and it is connected to the cartridge on one side and to the cartridge motion-enabling clip 8 on its opposing side.

FIGS. 2A, 2B, and 2C illustrate a preferred embodiment of an ink cartridge 4. The ink cartridge 4 comprises an elongated thin planar cartridge body 4A, which has an enclosed cavity 32 for ink storage, a writing tip 6 for releasing ink and a cavity stabilizer 24. The cavity stabilizer comprises a plurality of discrete strips spaced in a pattern adapted to define and stabilize the volume of the cavity within the cartridge.

Alternatively, the cavity stabilizer comprises an ink absorber. Preferably, the ink absorber is a material chosen from the group comprising sponges, fiber mats, and cloths.

In a further alternative embodiment, the cavity stabilizer comprises a plurality of discrete strips spaced in a pattern within an ink absorber and adapted to define and stabilize the volume of a cavity within the cartridge.

Preferably, the discrete strips are bonded to one or both cartridge body panels. The size and shape of the discrete strips as well as their number and position can vary as far as the cavity has a continuous and stable volume for ink storage. The edges of the cartridge body 26, 28 and 30 are liquid tight by bonding the edges of the top and bottom panels together or through a boarder strip 27. Preferably, the thickness of the boarder strip at the edges is similar to that of cavity stabilizer in the interior of the cartridge. In the embodiment shown in FIG. 2B, the boarder strip at the edges is thinner than the ink stabilizer in the interior, resulting in a slight curvature of the cartridge body.

Preferably, an air-venting hole 29 is provided at the distal end of the cartridge 30 opposing the writing tip 6. Preferably, the air-venting hole 29 is adapted to permit air to flow into the cavity and prevent liquid ink from leaking out. In a preferred embodiment, a gas-porous material fills the hole 29. The hole 29 may also be located in other positions on the cartridge body.

The writing tip may be a ball point type or felt type and it may be round or prismatic or other shapes depending on the type of writing instrument, which can be ball point pen, felt type pen, highlighter or marker.

The width and length of the cartridge may vary depending on the actual design of the pen. Preferably, the cartridge is sufficiently thin and the thickness may vary from the center to the edges transversely and longitudinally. The thickness of the cartridge can range from about 0.3 mm to about 8 mm and preferably from about 0.5 mm to about 4 mm. The shape of the planar cartridge may also vary in accordance with the desired design. For example, the shape of the cartridge may be round or square or any other regular or irregular shape. In particular, the shape and surface graphics of the cartridge can be adapted to resemble real or imagined objects or designs. More specifically, the shape of the ink cartridge is adapted to resemble a variety of beings, things, and designs including but limited to the group comprising cartoon characters, animals, plants, tools, vehicles, toys, weapons, armors, landscapes, buildings, human images, electronic devices, furniture etc. In general, the flat form of these writing instruments can provide a wide range of design possibilities to resemble variety of shapes and to display all kinds of information and graphics for advertisement, reference, education and entertainment purposes. The cartridge body may be rigid or flexible and may be made of metals or plastics or composites in ways similar to conventional cylindrical ink cartridges. Furthermore, the cartridge cavity stabilizer 24 may comprise discrete spacers of various shapes or comprise single or plural layers of ink absorbing materials such as sponge, fiber mat or cloth, or comprise a mix of spacers and an ink absorber. Depending on the design and manufacturing process, the cartridge body panels, spacers and boarder strips may be made from the same material or different materials. As well, the cartridge body panels, spacers and boarder strips may be made through injection molding or casting or machining or bonding. The cartridge body may comprise a continuous body or a plurality of pieces.

In a preferred embodiment, the thin and planar pen comprises simply a thin and planar ink cartridge.

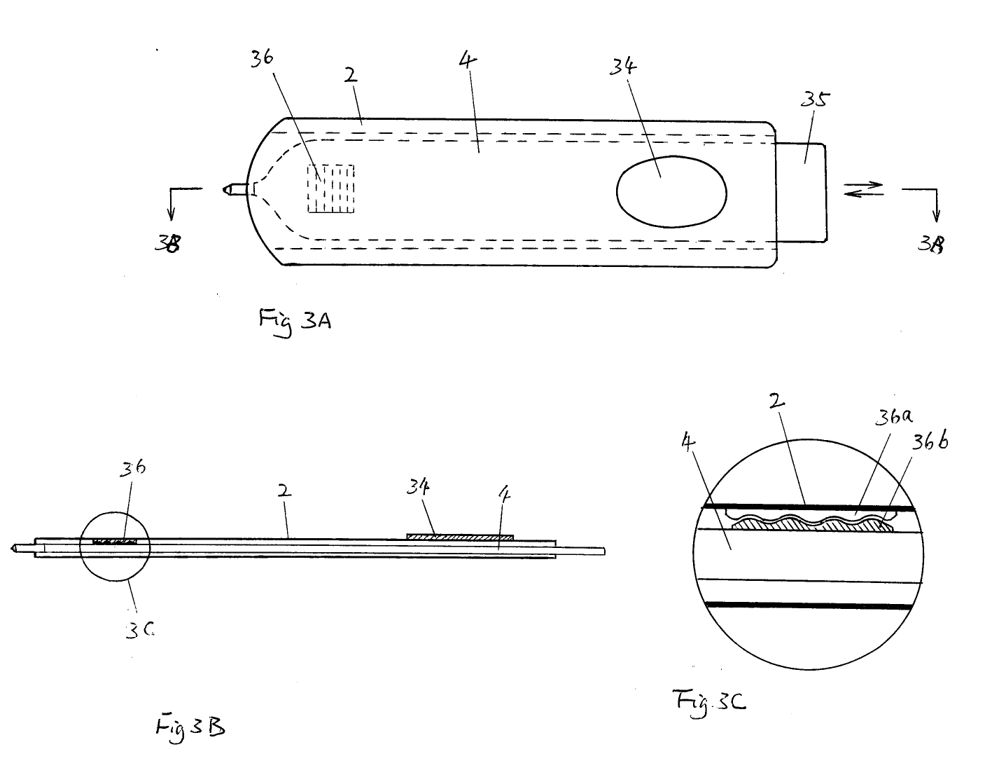

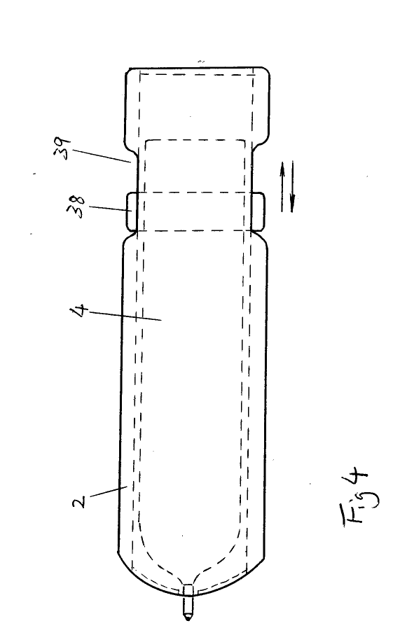

### FIG. 3-14—Additional Embodiments

There are many possibilities with regard to cartridge motion-enabling mechanism, anti-sliding mechanism, and hanging or clipping methods for the thin and planar writing instruments, which may be desirable under certain circumstances. FIG. 3 to 14 illustrate, by way of examples only, several alternative cartridge motion-enabling mechanisms. FIG. 3 shows that the rear end of the casing is open and a part of cartridge 35 extends out of the casing. This part can be hold by hand to move the writing tip in and out of the casing. As a further variation, the casing is separable from the ink cartridge to serve as a pen cap. The magnetic strip 34 allows the pen to be attached to any flat steel surfaces such as on a refrigerator.

FIG. 3C shows an anti-sliding device. The anti-sliding device is means for preventing the movement of the cartridge relative to the casing. It consists of two corrugated strips, 36, one bonded on the casing and the other on the cartridge. When the two strips are engaged due to the natural pressing by fingers during writing, the increased friction between the two strips prevents the movement of the cartridge relative to the casing. This device is useful in the case when increased friction between the cartridge and the casing is desirable.

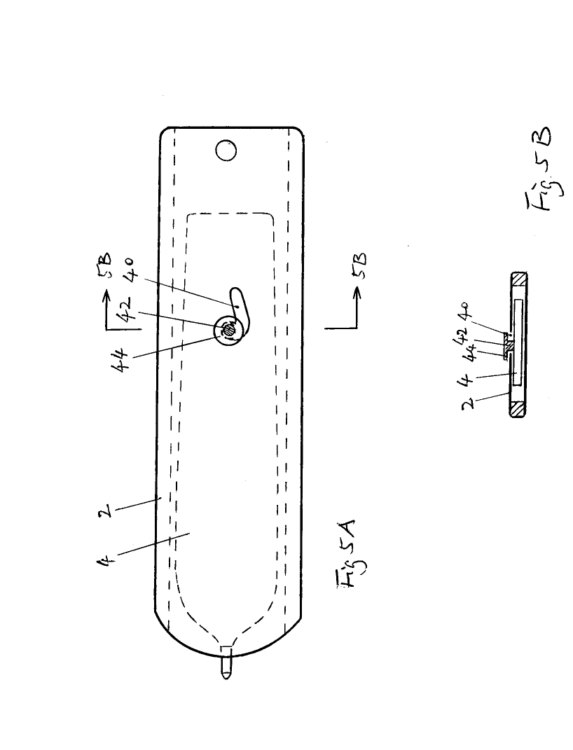

FIG. 4 shows an alternative motion-enabling mechanism by two handles 38, which are fixed on the ink cartridge, sticking out of the openings 39 on the two sides of the casing. Moving the handles longitudinally allows the writing tip to move in and out of the casing.

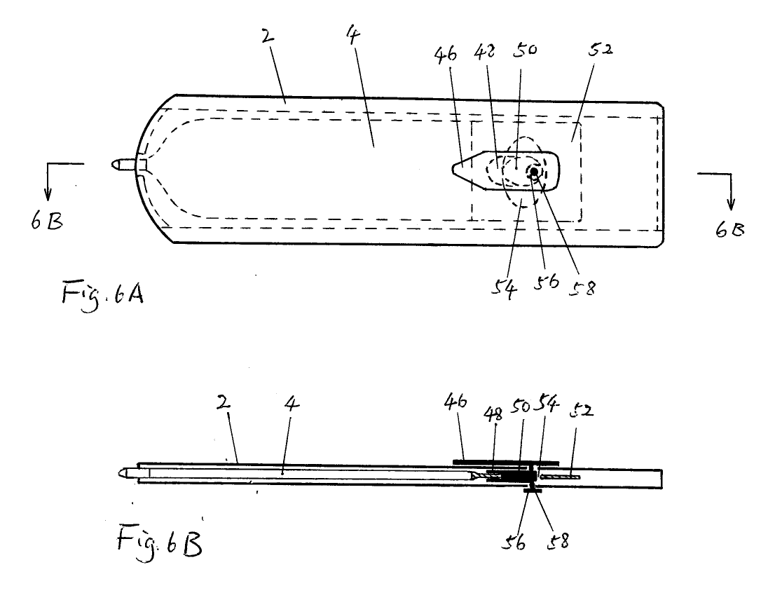

Another alternative motion enabling mechanism is shown in FIG. 5, in which a knob 42-44 connected on to the cartridge is exposed on top of one casing panel. The opening on the casing panel allows the knob to move or rest on two different positions, one for the writing tip to be inside the casing and one for the writing tip to be outside the casing.

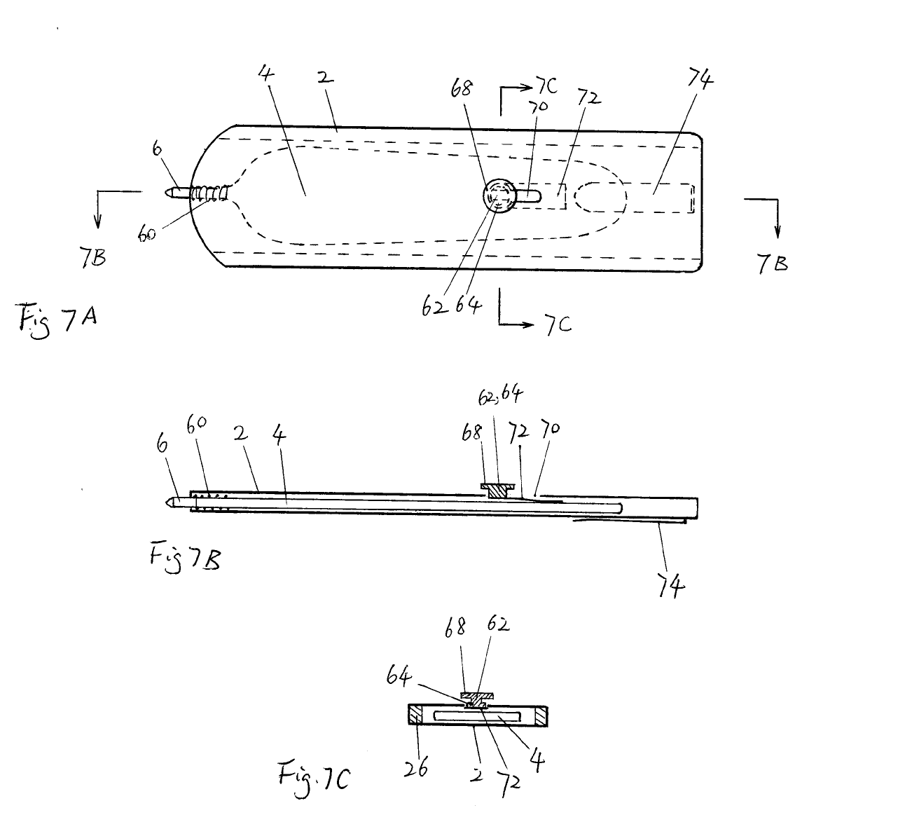

FIG. 6 shows another alternative motion-enabling mechanism, which is a strip 46 exposed on top of one casing panel and is connected to an oval shape wheel 50 through a pin 58. Two thin strips 48 confine the oval wheel within the oval opening of the casing panel. Pin 58 is joined with strip 46, wheel 50 and washer 56 but is not joined with the casing. Pin 58 is confined but not fixed in the holes on the top and bottom panels of the casing and can rotate in the holes. The writing tip is out of the casing when strip 46 points to the front end and is inside the casing when the strip points to the rear end.

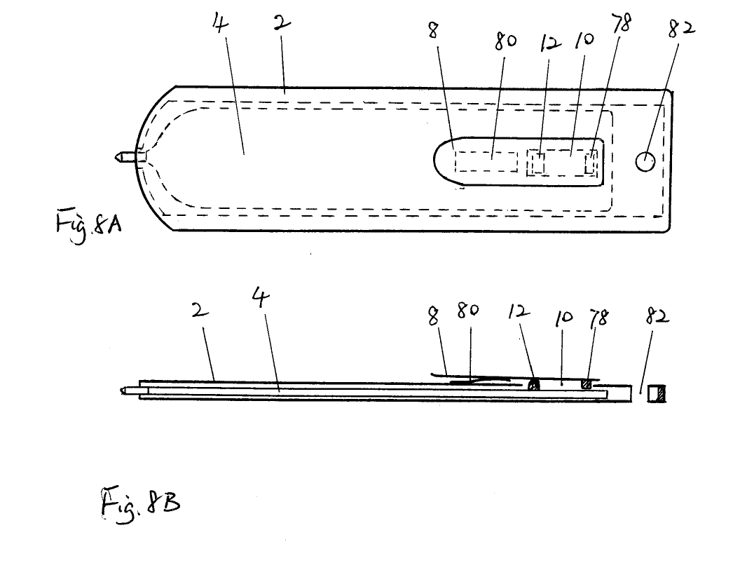

FIG. 7 shows another embodiment of the motion enabling mechanism. Here, the knob exposed through an opening on the casing panel is connected to a strip spring, which is fixed on the cartridge. The opening on the casing panel is larger at the front end allowing the knob to move up under the force of spring. Pushing down the knob allows the knob to move out of the opening. Moving the knob back and forth allows the writing tip to move in and out of the casing. Also, a spring 60 may be added on the narrow part of the cartridge for additional convenience in moving the writing tip into the casing. Also illustrated in FIG. 7 is a strip for clip the pen on papers.

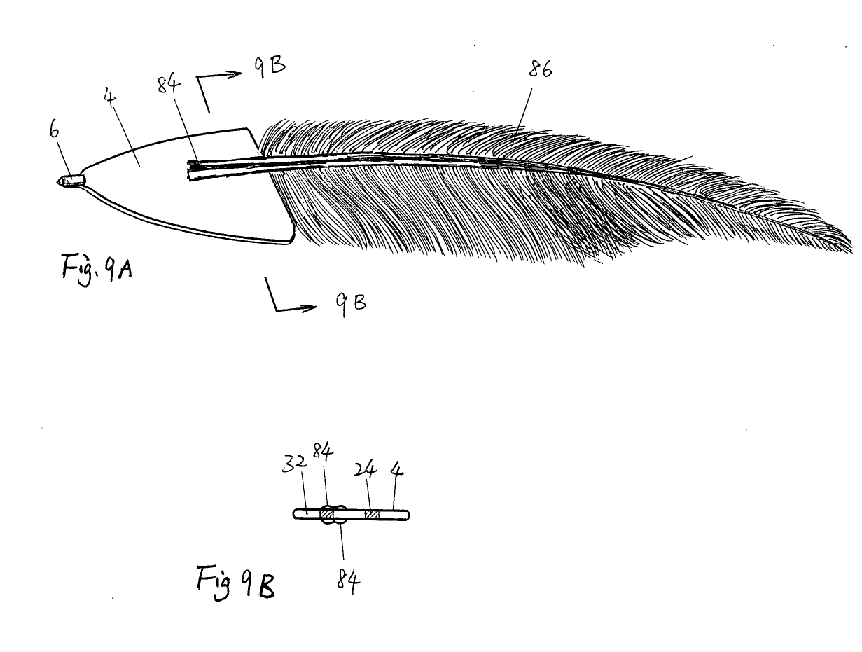

FIG. 8 shows a further example of alternative embodiment of motion enabling mechanism. Here, a strip 8 rests on a spring 80 and is jointed with the cartridge by a rivet 12 through an opening 10 on the casing. A small block 78 is at the rear end of the strip to serve as a lock to prevent the cartridge from moving back while writing. The hole 82 on the casing can be used to attach a string for decorative objects or for hanging the pen.

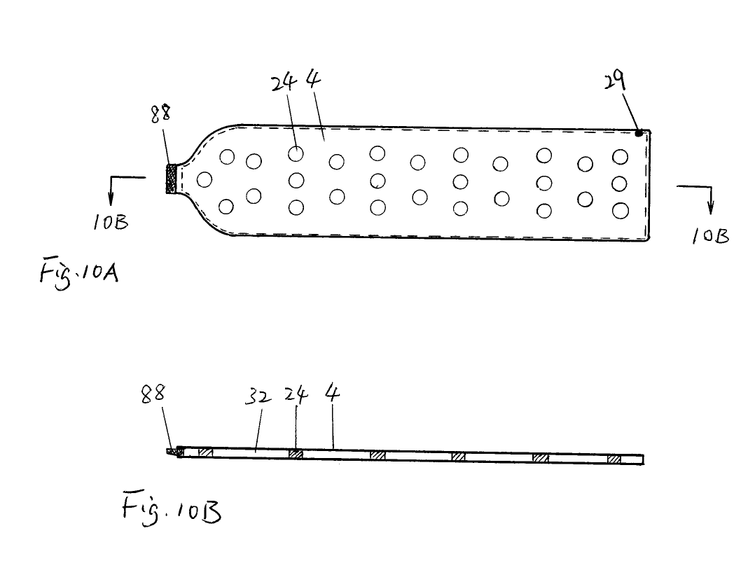

FIG. 9 shows a perspective view of a feather pen, which is a thin and planar pen 84 adapted to join with a feather 86. This embodiment has a look of an ancient quill pen but functions like a modern pen.

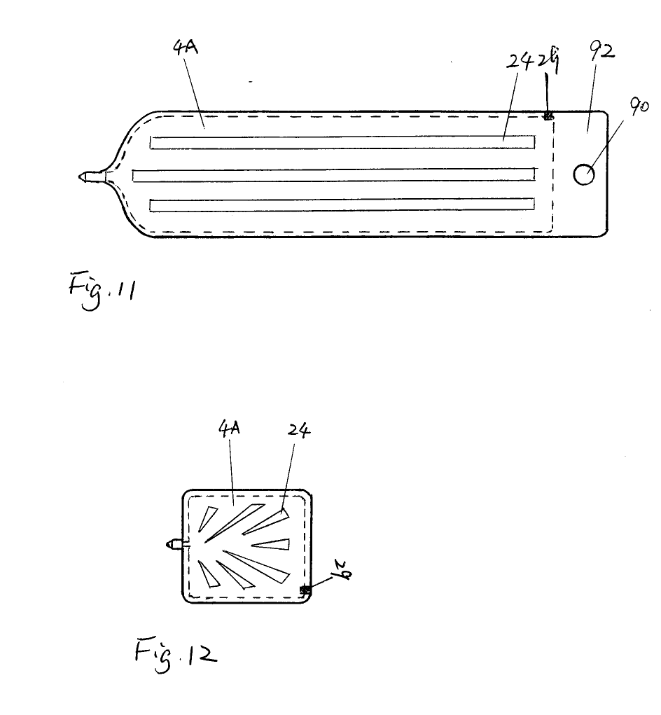

FIG. 10 shows a thin planar ink cartridge with a flat strip of felt type tip 88. The cartridge can either be used as a highlighter or a marker with or without a casing.

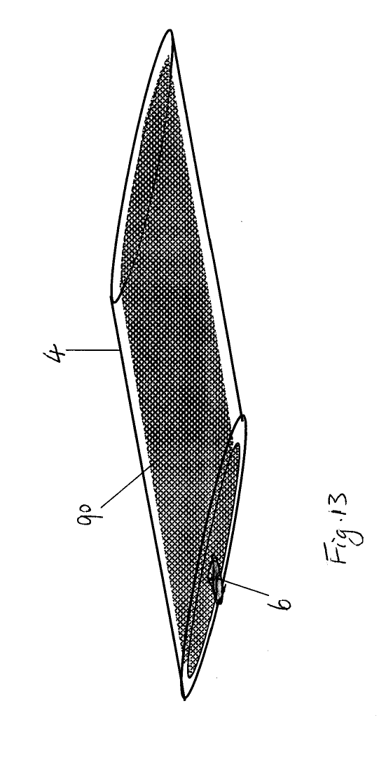

FIG. 11 shows another example of cartridge embodiment, in which the spacers are long stripes extending longitudinally in the cavity of the cartridge. The hole on the rear end of the cartridge can be used to attach a string for decorative objects or for hanging when cartridge is used as a pen.

FIG. 12 shows another embodiment of ink cartridge, which has a similar length transversely and longitudinally. The short length allows it, as a writing instrument with or without a casing, to be conveniently put inside a wallet, checkbook, notebook or pocket.

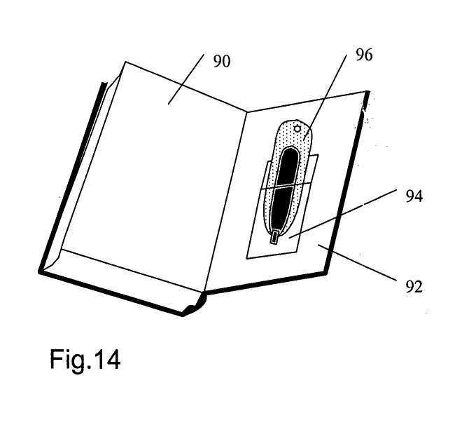

FIG. 13 shows another embodiment of ink cartridge, in which the cavity stabilizer is an ink absorber and has sufficient mechanical strength to provide stability of cavity volume inside the cartridge.

FIG. 14 shows a perspective book with a thin, planar highlighter and a casing. The casing is mounted on the backside of the book, which allows the highlighter to be placed inside the book when it is not in use. The casing also serves the function of a cap to prevent the ink from drying.

The various embodiments of the thin and planar writing instrument described and illustrated above are only by way of examples. It is obvious that the components in each embodiment, such as cartridge motion-enabling mechanisms, anti-sliding mechanism, clip, casing etc. can be used in variety of ways. Those having the skill in the art to which the present invention pertains, is now as a result of the applicant's teaching herein, perceive various modifications and additions, which may be made to the invention. It is understood that the general shape of the present invention, either ink cartridge or cartridge casing, may be readily altered to accommodate a variety of different gripping and visual preferences. It is also obvious that many peripheral or additional features and attachments, for example, an eraser, that are commonly applied in ordinary writing instruments, may be added without affecting the essence of the present invention. It is further understood that the shape of the thin and planar writing instruments may be round or square or rectangular or any other regular or irregular shape. Particularly, the shape and surface graphics of the thin and planar writing instruments can be designed to resemble real or imagined objects and images such as cartoon characters, plants, animals, cars, toys etc.

1. A thin and planar ink cartridge comprising,
a cartridge body,
an ink releasing writing tip,
an ink storage cavity, and
a cavity-stabilizer.

2. The thin and planar ink cartridge of claim 1, wherein the cavity stabilizer comprises discrete strips.

3. The thin and planar ink cartridge of claim 1, wherein the cavity stabilizer comprises an ink-absorber.

4. The thin and planar ink cartridge of claim 1 wherein the cavity stabilizer comprises a mix of discrete strips and an ink-absorber.

5. The thin and planar ink cartridge of claim 1 wherein the writing tip of the cartridge is a ballpoint.

6. The thin and planar ink cartridge of claim 1 wherein the writing tip of the cartridge is a felt-tip.

7. A writing instrument, comprising, a thin and planar ink cartridge.

8. The writing instrument of claim 7 is used as a bookmark and is adapted for easy placement between pages of a book or a document.

9. The writing instrument of claim 7 is a pen that is adapted to fit in wallets, checkbooks, notebooks, and pockets.

10. The writing instrument of claim 7 is used as a highlighter or a marker.

11. The writing instrument of claim 7 wherein the thin and planar ink cartridge affixed to a feather.

12. The writing instrument of claim 7, wherein the planar exterior surfaces are adapted to display advertising, reference, educational, and entertainment information.

13. The writing instrument of claim 7 wherein the shape of the ink cartridge is adapted to resemble a variety of objects, designs and images.

14. A writing instrument comprising a thin and planar ink cartridge, and a thin and planar casing that is adapted to receive and protect the cartridge.

15. The writing instrument of claim 14, wherein the casing is separable from the ink cartridge and adapted to cap the ink cartridge.

16. The writing instrument of claim 14 wherein the planar exterior surfaces are adapted to display advertising, reference, educational, and entertainment information.

17. The writing instrument of claim 14 wherein the shape of the casing is adapted to resemble a variety of objects, designs and images.

18. The writing instrument of claim 14, wherein a cartridge motion-enabling means for moving the writing tip in and out of the casing is provided.

19. The writing instrument of claim 14, wherein a cartridge motion-enabling means comprising a solid strip in exterior of a casing panel that is affixed to the ink cartridge through an opening on the casing panel.

20. The writing instrument of claim 14, wherein an anti-sliding means comprising two corrugated strips with one being bonded on the casing and the other being bonded on the ink cartridge is provided.
